(19) United States
(12) Patent Application Publication
(10) Pub. No.: US 2020/0318033 A1
(43) Pub. Date: Oct. 8, 2020

(54) DETERGENT COMPOSITIONS

(71) Applicant: Conopco, Inc., d/b/a UNILEVER, Englewood Cliffs, CA (US)

(72) Inventors: Julie Bennett, Merseyside (GB); David Christopher Thorley, Merseyside (GB)

(21) Appl. No.: 16/303,574

(22) PCT Filed: May 22, 2017
(86) PCT No.: PCT/EP2017/062315

§ 371 Date: Nov. 20, 2018

(30) Foreign Application Priority Data
May 24, 2016 (EP) 16171146.0

(51) Int. Cl. C11D 1/37; C11D 11/00; C11D 1/83

(52) U.S. Cl. CPC C11D 1/37; C11D 1/22; C11D 1/83; C11D 11/0017

(57) ABSTRACT

Detergent compositions comprising a surfactant system which is 10 wt % to 70 wt % soap. Detergent compositions which are easily rinsed. Laundry methods using such compositions.

The present invention relates to a detergent comprising a surfactant system which is at least 10 wt % soap and suitably less than 70 wt % soap.

Foaming may be desirable when washing clothes, in particular when hand washing, as it may improve cleaning and/or enhance user perception of efficacy. If a product does not foam, users may think that the product is not working, or that insufficient product has been added.

However, following the washing step, it is common for an appreciable amount of surfactant to remain in the fabric fibres and on the fabric surface. This may be referred to as “carry-over”. As a result, significant amounts of foaming occur in the rinse step. This carry over typically persists over multiple rinses. This can result in three, four, or even more rinses people tend to rinse clothes until there is minimal foam, soapy feel, or turbidity in the rinse liquor.

Naturally, this repeated rinsing increases water consumption, posing environmental concerns, especially in water stressed countries. Furthermore, the sudsy water is often discarded, without further use.

It is therefore desirable to reduce carry over for foaming compositions.

Previous attempts to address this problem include the following.

One approach minimises the surfactant content of the detergent. This reduces the amount of suds during rinse steps, but at the cost of foaming during the wash steps.

Another approach provides detergent compositions containing rinse-agents, anti-foams and defoamers, to reduce foaming during rinse. The amount added must be carefully determined to minimise loss of foaming during the wash steps. These additional ingredients also increase cost and waste.

The invention addresses the problem a foaming wash detergent that rinses more efficiently in a different way.

The inventors have surprisingly found that increasing the relative amount of soap in the composition to levels significantly greater than those usually added to detergents results in a well-foaming main wash product which appears to rinse easier than conventional detergents.

The invention relates to a detergent composition comprising a surfactant system which is at least 10 wt % soap and suitably less than 70 wt % soap.

As described herein, the term soap refers to carboxylate salts of fatty acids.

Accordingly, in a first aspect, the invention may provide a detergent composition comprising a surfactant system which is 10 wt % to 70 wt % soap.

In some cases, the surfactant system is less than 60 wt % soap, for example less than 50 wt % soap.

In some cases, the surfactant system is at least 15 wt % soap, for example 20 wt % soap or higher, or even 25 wt % or 30 wt % soap or higher.

For example, the surfactant system may be 20 wt % to 50 wt % soap, for example 30 wt % to 50 wt %.

It will be understood that surfactant system, as used herein, describes the total surfactant content of the composition.

In some cases, surfactant system may account for up to 25 wt % of the composition.

Preferably, the surfactant system accounts for up to 20 wt % of the composition, for example up to 15 wt % of the composition.

Suitably, the surfactant system accounts at least 5 wt % of the composition.

For example, it may be at least 8 wt % or at least 12 wt %.

Suitably, the detergent composition is a liquid detergent composition. For example, it may be a laundry liquid formulated for use in laundry. The surfactant system may account for between 12 wt % and 20 wt % of the composition. The detergent composition may be formulated as a hand wash composition for washing items in a sink. The surfactant system may account for between 8 wt % and 20 wt % of the composition.

A soap is a carboxylate salt of a fatty acid. The soap content of the compositions of the invention may consist of a single soap compound or a mixture of soap compounds. In some cases, a single fatty acid carboxylate is used. The counter ion may be a single counter ion or mixture of counter ions.

Suitable counter ions are known in the art and include potassium and sodium ions as well as organic amine based counter ions such as those based on triethanolamine.

The fatty acid carboxylate may be unsaturated or saturated. For example, the fatty acid may comprise one or more double bond. Preferably, the soap is >50% mono unsaturated.

The fatty acid may be a C10-30 compound, for example a 015-25 compound.

A suitable fatty acid is oleic acid. In these cases, the soap is >50 wt % a carboxylate salt of oleic acid. For example, it may be the potassium salt. In other words, the soap may be >50 wt % potassium oleate.

In some cases, the soap is >75 wt % a carboxylate salt of oleic acid, for example >90 wt % or even >95 wt %.

The remainder of the total surfactant is non-soap surfactants. Suitable non-soap surfactants include linear alkyl benzene sulphonates (LAS), alcohol sulphates such as primary alcohol sulphates (PAS), alkyl ether sulphates (AES), amine oxides (AO), methyl ester sulphonates (MES), and alcohol ethoxylates (NI).

For example, the surfactant system may comprise linear alkyl benzene sulphonate (LAS), primary alcohol sulphate (PAS) and soap. In some cases, the amounts are 40-45 wt %, 1-10 wt % and 40-50 wt %, respectively.

For example, the surfactant system may be linear alkyl benzene sulphonate (LAS) about 50 wt %, soap (preferably potassium oleate) about 45 wt %, and primary alcohol sulphate about 5 wt %.

In other examples, the surfactant system may comprise alkyl ether sulphate (AES), amine oxide (AO) and soap. In some cases, the amounts are 72-40 wt %, 10-30 wt % and 40-10 wt %, respectively.

For example, the surfactant system may comprise alkyl ether sulphate (AES) about 48-55 wt %, amino oxide (AO) about 18-22 wt %, and soap about 28-35 wt %.

For example, the surfactant system may comprise alkyl ether sulphate (AES) about 48 wt %, amino oxide (AO) about 20 wt %, and soap about 32 wt %.

The invention further provides a method of laundering articles, the method comprising forming a wash liquor by diluting the composition of any preceding claims in water; then agitating articles immersed in said wash liquor; then draining the wash liquor from said articles; then rinsing said articles in one or more rinse steps.

Suitably, the articles are fabric items such as clothing, household linen and curtains, canvas and industrial fabrics.

As described herein, the composition of the invention may lead to fewer rinses in laundry methods as the inventors have observed that that less foam is observed in the rinse step conditions for the tested compositions.

Suitably, the method comprises three or fewer rinse steps. In some cases, the method comprises two rinse steps only.

This makes the compositions of the present invention especially suitable for hand washing laundry methods. In some cases therefore, the method is not in an automatic washing machine. Instead, the method may be in wash tub, sink or similar. This may be referred to as hand washing.

### EXAMPLES

### Example 1

A composition according to the present invention comprises:

| | | |
|---|---|---|
| Potassium linear alkylbenzene sulfonates (K-LAS) | 7.5 | wt % |
| Potassium oletate (K-oleate) | 6.75 | wt % |
| Potassium primary alkyl sulfonates | 0.75 | wt % |

The surfactant content of the composition is 15 wt %.

This was compared to a currently marketed laundry liquid detergent having the following active composition: Na-LAS, nonionic 7EO, sodium alkyl ether sulphate (2EO), sodium salt of hardened lauric acid.

A wash solution was prepared by adding the composition to water to yield a concentration of 5 grams per litre. The water contained calcium ions at a concentration of 0.8 mmolar and magnesium ions at a concentration of 0.04 mmolar.

A rinse solution was prepared in the same way but the compositions were added at a concentration of 0.25 grams per litre.

20 ml of each solution was added to a 100 ml stoppered measuring cylinder. The cylinders were shaken by hand 10 times in a vertical plane. The volume of foam in the cylinder was recorded after standing for 10 seconds.

The composition of the invention gives similar foaming in the wash steps, but reduced foaming at lower concentrations (i.e. in rinse steps), meaning that the laundry may be more easily rinsed.

1. A detergent composition comprising a surfactant system which is 10 wt % to 70 wt % soap.

2. The detergent composition of claim 1, wherein the detergent composition is a liquid composition.

3. The detergent composition of claim 1, wherein the surfactant system accounts for 5 wt % to 20 wt % of the composition.

4. The detergent composition of claim 1, wherein the soap is greater than 50 wt % mono unsaturated fatty acid carboxylate salt.

5. The detergent composition of claim 1, wherein the soap is greater than 50 wt % oleate salt.

6. The detergent composition of claim 5, wherein the soap is greater than 95 wt % oleate salt.

7. The detergent composition of claim 1, wherein the surfactant system is 30 wt % to 50 wt % soap.

8. The detergent composition of claim 1, wherein the surfactant system comprises one or more surfactants selected from linear alkyl benzene sulphonate (LAS), alcohol sulphate, alkyl ether sulphate (AES), and amine oxide (AO).

9. The detergent composition of claim 1, wherein the surfactant system comprises linear alkyl benzene sulphonate (LAS) and alcohol sulphate.

10. The detergent composition of claim 1, wherein the surfactant system comprises alkyl ether sulphate (AES) and amino oxide (AO).

11. A method of laundering articles, the method comprising:
forming a wash liquor by diluting the composition of claim 1 in water; then
agitating articles immersed in said wash liquor; then
draining the wash liquor from said articles; then
rinsing said articles in one or more rinse steps.

12. The method of claim 11, wherein the method comprises three or fewer rinse steps.

13. The method of claim 11, wherein the method of laundering articles is not in an automatic washing machine.

14. The detergent composition of claim 5, wherein the oleate salt is potassium oleate.

15. The detergent composition of claim 6, wherein the oleate salt is potassium oleate.

16. The detergent composition of claim 9, wherein the surfactant system comprises linear alkyl benzene sulphonate (LAS) and primary alcohol sulphate (PAS).

17. The method of claim 12, wherein the method comprises two rinse steps only.
